(19) United States
(12) Patent Application Publication
(10) Pub. No.: US 2013/0108053 A1
(43) Pub. Date: May 2, 2013

(54) GENERATING A STEREO AUDIO DATA PACKET

(71) Applicant: Otto A. GYGAX, Philomath, OR (US)

(72) Inventor: Otto A. GYGAX, Philomath, OR (US)

(21) Appl. No.: 13/285,668

(22) Filed: Oct. 31, 2011

(51) Int. Cl. H04R 5/00

(52) U.S. Cl. 381/17

(57) ABSTRACT

In one implementation, audio signals from at least one audio input device are received. In addition, a first weight for the at least one audio input device is applied to the audio signals to generate a plurality of weighted left channel audio signals and a second weight for the at least one audio input device is applied to the audio signals to generate a plurality of weighted right channel audio signals. Moreover, stereo audio signals containing the weighted left channel audio signals and the weighted right channel audio signals are generated.

### BACKGROUND

Modern technology has enabled traditional meetings to be replaced, partially replaced, or enhanced by some form of a technology-assisted meeting or virtual meeting. One manner of availing virtual meetings is a telepresence solution, which refers to a technology that allows participants to receive stimuli that makes them feel as if they are in the presence of other users during virtual meetings. In this regard, for instance, telepresence solutions often include life size video images of the other participants as well as similarities in the appearances of the separate rooms or studios from which the participants conduct the virtual meetings. Telepresence solutions also often attempt to output audio to correspond to the correct displays to further enhance the virtual meeting experience.

### BRIEF DESCRIPTION OF THE DRAWINGS

Features of the present disclosure are illustrated by way of example and not limited in the following figure(s), in which like numerals may indicate like elements, in which:

FIG. 1 shows a block diagram of an audio signal communication environment, in which various aspects of the methods and apparatuses disclosed herein are to be implemented, according to an example of the present disclosure;

FIG. 2 depicts a block diagram of the audio signal generating apparatus depicted in FIG. 1, according to an example of the present disclosure;

FIG. 3 depicts a flow diagram of a method for generating a stereo audio signal contained in a data packet stream, according to an example of the present disclosure;

FIG. 4 illustrates a diagram that graphically depicts how the respective first and second weights are applied to each of the audio signals of three audio input devices to generate a summed left channel audio signal and a summed right channel audio signal, according to an example of the present disclosure;

FIG. 5 depicts a block diagram of the audio signal outputting apparatus depicted in FIG. 1, according to an example of the present disclosure;

FIG. 6 depicts a flow diagram of a method for outputting a stereo audio signal contained in a data packet stream, according to an example of the present disclosure;

FIG. 7 illustrates a diagram that graphically depicts how the respective left and right weights for each of three audio output devices are applied to each of the left channel audio signal and the right channel audio signal for output of the weighted audio signals on the audio output devices, according to an example of the present disclosure; and

FIG. 8 shows a schematic representation of a computing device, which is employed to perform various functions of either or both of the audio signal generating apparatus and the audio signal outputting apparatus depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are methods and apparatuses for processing audio signals to be communicated from at least one audio input device to at least one audio output device located at a separate location from the at least one audio input device. In one regard, the audio signals are processed to substantially preserve spatialization of audio input devices following communication of the audio signals from the audio input devices to the audio output devices. The methods and apparatuses disclosed herein enable the spatialization, which is defined herein as the use of the localization of sounds in physical space, of the audio input sources to be substantially preserved following communication of the audio signals through a single data packet stream. As such, bandwidth requirements for the communication of the audio signals may be kept within a desired range, while still preserving the spatialization. In other examples, the same signals are transmitted over both the left and right channels of the stereo signal, such that, monoaural signals are communicated.

The data packet stream is generated based upon the arrangement of the audio input devices at the source location, without requiring knowledge of the output devices through which the audio signals are to be outputted. In addition, the data packet stream is outputted based upon the arrangement of the audio output devices at the destination location, without requiring knowledge of the input devices from which the audio signals were generated. As such, the methods and apparatuses disclosed herein enable the spatialization to be substantially preserved between a disparate number of audio input sources and audio output devices.

Through implementation of the methods and apparatuses disclosed herein, audio signals captured in multiple areas in a first location are to be outputted through a plurality of audio output devices that are positioned in multiple areas of a second location, while substantially maintaining the spatialization of the captured audio signals. Thus, for instance, audio signals captured from the left side of the first location are predominantly played back from audio output devices located in the left side of the second location, while audio signals captured from the right side of the first location are predominantly played back from audio output devices located in the right side of the second location. The first and second locations comprise, for instance, videoconferencing rooms, telepresence studios, locations in which videoconferencing equipment have been set up, etc. As such, for instance, the audio signals of a speaker whose image is being displayed on a left most display is matched to that display by outputting the audio signals predominantly from audio output devices located near the left most display. Thus, implementation of the methods and apparatuses disclosed herein, along with other components of videoconference rooms, such as, multiple displays, make it appear to the participants of a virtual meeting that they are in the same room. This generally enhances the participants' sense of immersion in the videoconference.

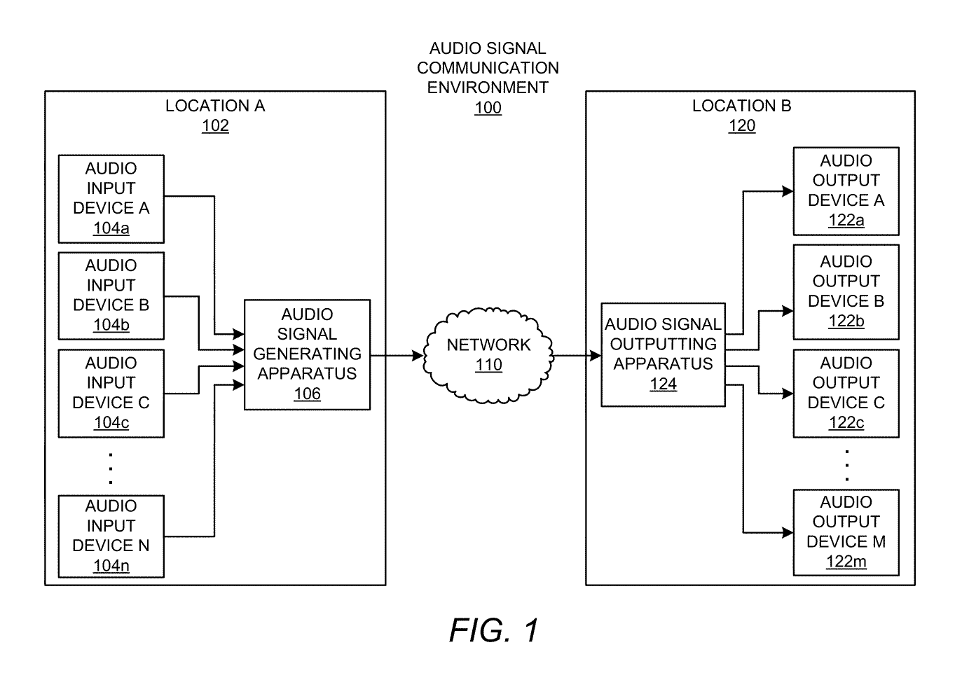

With reference first to FIG. 1, there is shown a block diagram of an audio signal communication environment 100, in which various aspects of the methods and apparatuses disclosed herein are to be implemented, according to an example of the present disclosure. As depicted in FIG. 1, the audio signal communication environment 100 includes a first location 102 having a plurality of audio input devices 104a-104n and an audio signal generating apparatus 106. The audio signal communication environment 100 is also depicted as including a second location 120 having a plurality of audio output devices 122a-122m and an audio signal outputting apparatus 124. The audio signal generating apparatus 106 in the first location 102 is further depicted as being in communication with the audio signal outputting apparatus 124 through a network 110, which comprises, for instance, the Internet, an intranet, a Local Area Network (LAN), a telecommunications network, etc.

As will be described in greater detail herein below, the audio signal generating apparatus 106 is to receive audio input signals from each of the audio input devices 104a-104n, in which the variable “n” comprises zero or any integer greater than one. In this regard, the audio signal generating apparatus 106 may receive audio input signals from a single audio input device 104a or from multiple audio input devices 104a-104n. Each of the audio input devices 104a-104n is assigned a respective left channel weight and a respective right channel weight. The weights comprise values that correspond to the positions of the audio input devices 104a-104n with respect to each other and with respect to the location 102. Thus, for instance, the left channel weight for the audio input device 104a positioned at the leftmost position is substantially higher than the right channel weight for that audio input device 104a. Likewise, the left channel weight for the audio input device 104n positioned at the rightmost position is substantially lower than the right channel weight for that audio input device 104n. Thus, for instance, spatialization of the audio input devices 104a-104n is able to be maintained in the weighted left channel audio signals and the weighted right channel audio signals.

In any regard, the audio signal generating apparatus 106 applies a first set of respective weights for the audio input devices 104a-104n to the audio signals to generate a plurality of weighted left channel audio signals. The audio signal generating apparatus 106 also applies a second set of respective weights for the audio input devices 104a-104n to the audio signals to generate a plurality of weighted right channel audio signals. In addition, the audio signal generating apparatus 106 generates stereo audio signals containing the weighted left channel audio signals and the weighted right channel audio signals. More particularly, the audio signal generator 106 sums the plurality of weighted left channel audio signals together to generate a left channel signal of the stereo audio signal. Likewise, the audio signal generating apparatus 106 sums the plurality of weighted right channel audio signals together to generate a right channel signal of the stereo audio signal. Moreover, the audio signal generating apparatus 106 generates a data packet stream containing the stereo audio signals.

The audio signal generating apparatus 106 outputs the data packet stream containing the stereo audio signals to the audio signal outputting apparatus 124 through the network 110. The audio signal outputting apparatus 124 receives the data packet stream containing the stereo audio signals, in which the stereo audio signals contain a left channel audio signal and a right channel audio signal. As will be described in greater detail herein below, the audio signal outputting apparatus 124 outputs the left channel audio signal and the right channel audio signal in a weighted fashion respectively over the audio output devices 122a-122m, in which the variable “m” comprises zero or any integer greater than one. In this regard, the audio signal outputting apparatus 124 may output audio input signals to a single audio output device 122a or to multiple audio output devices 122a-122m. More particularly, the audio signal outputting apparatus 124 outputs the left channel audio signal and the right channel audio signal over the audio output devices 122a-122m in manners that may substantially accurately represent the spatial locations of the audio input devices 104a-104n from which the stereo audio signals were received.

The audio signal outputting apparatus 124 accomplishes this substantial preservation of the spatial locations of the audio input devices 104a-104n by applying a respective left channel weight on the left channel audio signal for each of the audio output devices 122a-122m and by applying a respective right channel weight on the right channel audio signal for each of the audio output devices 122a-122m. More particularly, each of the audio output devices 122a-122m is assigned a respective left channel weight and a respective right channel weight, which are respectively applied to the left channel audio signal and the right channel audio signal for each of the audio output devices 122a-122m. According to an example, the individual weights applied to the left channel audio signal and the right channel audio signal vary the decibel levels of the audio outputs by each of the audio output devices 122a-122m.

By way of example, the left channel weight for the audio output device 122a positioned at the leftmost position in the second location 120 is substantially higher than the right channel weight for that audio output device 122a. Likewise, the left channel weight for the audio output device 122m positioned at the rightmost position in the second location 120 is substantially lower than the right channel weight for that audio output device 122m. Various manners in which the respective weights of the audio output devices 122a-122m are applied to the left channel audio signal and the right channel audio signal are described in greater detail herein below.

The locations 102 and 120 comprise various types of locations in which audio signals are to be collected and communicated and represent any number of various locations. By way of example, the locations 102 and 120 comprise videoconferencing rooms, telepresence studios, locations in which videoconferencing equipment have been set up, etc. As such, although not shown, for instance, the locations 102 and 120 include additional components, such as, displays, cameras, computers, etc. In addition, the first location 102 includes any number of audio input devices and the second location 120 includes any number of audio output devices, in which the number of audio input devices in the first location 102 may differ from the number of audio output devices 120 in the second location 120. The first location 102 and the second location 120 may be located geographically remotely from each other, for instance, in different states, different countries, etc. Alternatively, the first location 102 and the second location 120 may be located in the same building, in neighboring buildings, etc.

The audio input devices 104a-104n generally comprise any suitable devices that convert acoustic waves into electric signals, such as, microphones. In any regard, the audio input devices 104a-104n are arranged in spatially different positions with respect to each other in the first location 102. By way of example in which the first location 102 comprises a videoconferencing location, the audio input devices 104a-104n are positioned at various positions around the videoconferencing location to capture sounds from the various positions. In addition, the audio input devices 104a-104n communicate the electric signals representing the captured audio signals to the audio signal generating apparatus 106. The audio input devices 104a-140n communicate the electric signals to the audio signal generating apparatus 106 over a wired and/or wireless connection.

The audio output devices 122a-122m generally comprise any suitable devices that convert electric signals into acoustic waves, such as, speakers. In any regard, the audio output devices 122a-122m are arranged in spatially different positions with respect to each other in the second location 120. For instance, the audio output devices 122a-122m are arranged at the spatially different positions in the second location 120 to substantially enable audio to be delivered throughout the second location 120. By way of example in which the first location 102 and the second location 120 comprise separate videoconferencing locations, the audio input devices 104a-104n are positioned at various positions around the first videoconferencing location to capture sounds from the various positions. In addition, the audio output devices 122a-122m are positioned at various positions around the second videoconferencing location, such as, for instance, adjacent to respective displays. In any regard, the audio output devices 122a-122m receive electric signals from the audio signal outputting apparatus 124. The electric signals are communicated from the audio signal outputting apparatus 124 to the audio output devices 122a-122m over a wired and/or wireless connection.

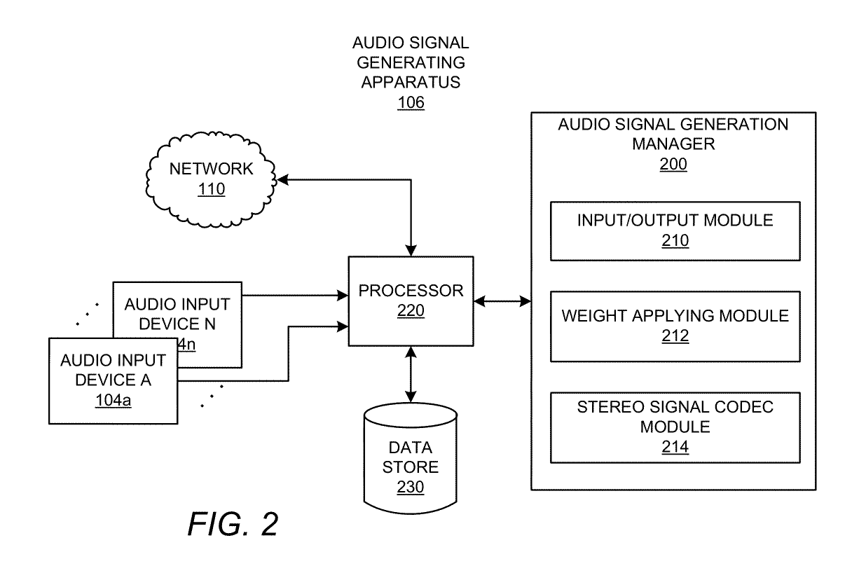

Turning now to FIG. 2, there is shown a block diagram of the audio signal generating apparatus 106 depicted in FIG. 1, according to an example of the present disclosure. As shown in FIG. 2, the audio signal generating apparatus 106 comprises an audio signal generation manager 200, a processor 220, and a data store 230. The audio signal generation manager 200 is also depicted as including an input/output module 210, a weight applying module 212, and a stereo signal codec module 214. The processor 220 is depicted as communicating with the audio input devices 104a-104n, the data store 230, and the network 110.

The audio signal generating apparatus 106 comprises a server, a computer, or other electronic device comprising logic, hardware and/or software, to perform various functions described herein. In addition, the audio signal generation manager 200 comprises at least one of hardware and machine readable instructions stored on a memory or an integrated chip programmed to perform various audio signal processing operations. In this regard, the modules 210-214 comprise at least one of software modules and/or hardware modules. The modules 210-214 thus may comprise machine-readable instructions that are stored, for instance, in a volatile or non-volatile memory, such as DRAM, EEPROM, MRAM, flash memory, floppy disk, a CD-ROM, a DVD-ROM, or other optical or magnetic media, and the like, and executable by the processor 220. According to an example, the modules 210-214 are stored in the data store 230, which comprises any of the above-listed types of memory. According to another example, the modules 210-214 comprise at least one hardware device, such as, a circuit or multiple circuits arranged on a printed circuit board that are controlled by the processor 220.

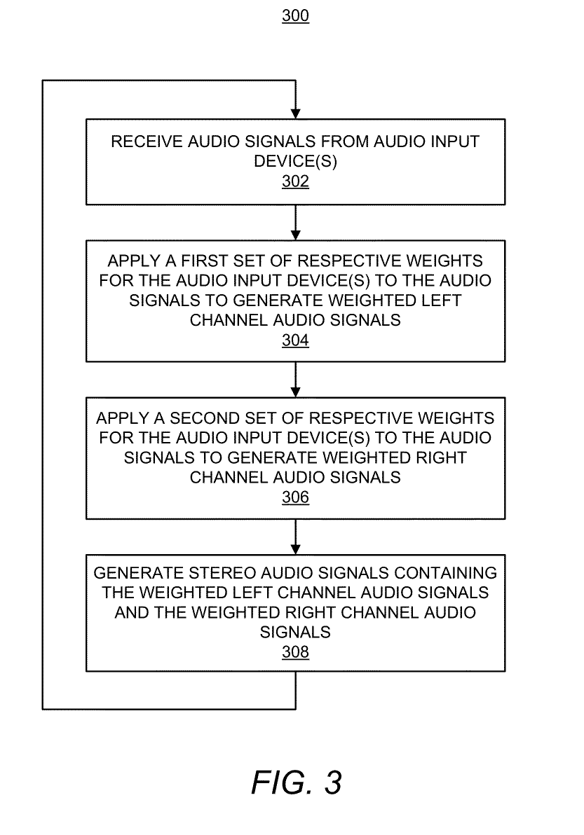

Various manners in which the modules 210-214 are implemented in accordance with examples of the present disclosure are described in greater detail below with respect to the method 300 depicted in FIG. 3. FIG. 3, more particularly, shows a flow diagram of a method 300 for generating a stereo audio signal contained in a data packet stream, according to an example of the present disclosure.

According to an example, the audio signal generation manager 200 implements the method 300 to generate the stereo audio signal data packet stream in a manner, for instance, that substantially preserves spatializations of the audio input devices 104a-104n. In this regard, and as discussed in greater detail herein below, the stereo audio signal data packet stream is processed by a receiving apparatus in a manner that enables the audio signals to be played back while substantially preserving spatializations of the audio input devices.

At block 302, audio signals are received into the audio signal generation manager 200 from at least one audio input device 104a-104n, for instance, by the input/output module 210. Alternatively, audio signals are received into the audio signal generation manager 200 from a plurality of the audio input devices 104a-104n. More particularly, each of the audio input devices 104a-104n, when activated, is to communicate electric signals converted from acoustic waves captured on the audio input devices 104a-104n. As such, the audio signal generation manager 200 substantially concurrently receives from the audio input devices 104a-104n, the electric signals representing the acoustic waves captured by each of the audio input devices 104a-104n. According to an example, an audio stream input/output (ASIO) (not shown) collects the electric signals from the audio input devices 104a-104n and communicates the electric signals to the audio signal generating apparatus 106. More particularly, for instance, the ASIO may be associated with drivers that execute the actual signal data transport between the audio input devices 104a-104n and the software layers of the audio signal generating apparatus 106. In this example, the ASIO is positioned in the communication path between the audio input devices 104a-104n and the processor 220 depicted in FIG. 2.

At block 304, a first weight is applied to the audio signals received from the at least one audio input device 104a-104n to generate a plurality of weighted left channel audio signals, for instance, by the weight applying module 212. Alternatively, at block 304, a first set of respective weights is applied to each of the audio signals received from the audio input devices 104a-104n to generate a plurality of weighted left channel audio signals, for instance, by the weight applying module 212. In other words, a first weight (w_{1A}) for a first audio input device 104a is applied to the audio signal received from the first audio input device 104a. In addition, a first weight (w_{1B}) for a second audio input device 104b is applied to the audio signal received from the second audio input device 104b. Moreover, a first weight (w_{1C}) for a third audio input device 104c is applied to the audio signal received from the third audio input device 104c. Likewise, respective first weights (w_{1D-1N}) for the remaining audio input devices 104d-104n, as applicable, are applied to the remaining audio input devices 104d-104n. According to an example, the first and second sets of respective weights for the audio input devices 104a-104n are applied by multiplying the weights with the audio signals, which may be in decibels, for instance. In addition, the weights comprise fractional values, scaled values, or similar values that either increase or decrease the values of the audio signals.

By way of example, the values of the weights in the first set of respective weights are to cause left channel audio signals to favor the audio input devices 104a-104n that are located closer to the left side of the location 102. In this example, for instance, the first weight (w_{1A}) for the first audio input device 104a is larger than the first weight (w_{1B}) for the second audio input device 104b and the first weight (w_{1B}) for the second audio input device 104b is larger than the first weight (w_{1C}) for the third audio input device 104c.

At block 306, a second weight is applied to each of the audio signals received from the at least one audio input device 104a-104n to generate a plurality of weighted right channel audio signals, for instance, by the weight applying module 212. Alternatively, at block 306, a second set of respective weights is applied to each of the audio signals received from the audio input devices 104a-104n to generate a plurality of weighted right channel audio signals, for instance, by the weight applying module 212. In other words, a second weight (w_{2A}) for the first audio input device 104a is applied to the audio signal received from the first audio input device 104a. In addition, a second weight (w_{2B}) for the second audio input device 104b is applied to the audio signal received from the second audio input device 104b. Moreover, a second weight (w_{2C}) for a third audio input device 104c is applied to the audio signal received from the third audio input device 104c. Likewise, respective second weights (w_{2D-2N}) for the remaining audio input devices 104d-104n, as applicable, are applied to the remaining audio input devices 104d-104n.

According to an example, the values of the weights in the second set of respective weights are to cause right channel audio signals to favor the audio input devices 104a-104n that are located closer to the right side of the location 102. In this example, for instance, the second weight (w_{2A}) for the first audio input device 104a is smaller than the second weight (w_{2B}) for the second audio input device 104b and the second weight (w_{2B}) for the second audio input device 104b is smaller than the second weight (w_{2C}) for the third audio input device 104c.

In some implementations, the weights in the first set of weights (w_{1A}-w_{1N}) and the second set of weights (w_{2A}-w_{2N}) comprise values that are based at least upon the spatial positions of the audio input devices 104a-104n from which the audio signals are received into the audio signal generating apparatus 106. That is, the values of the weights in the first set of weights (w_{1A}-w_{1N}) and the second set of weights (w_{2A}-w_{2N}) are likely to differ for instances where there is a first number of audio input devices 104a-104n and where there is a second number of audio input devices 104a-104n. Likewise, the values of the weights in the first set of weights (w_{1A}-w_{1N}) and the second set of weights (w_{2A}-w_{2N}) are likely to differ for instances where the audio input devices 104a-104n are arranged in a first spatial arrangement and where the audio input devices 104a-104n are arranged in a second spatial arrangement. According to an example, the values of the weights in the first set of weights (w_{1A}-w_{1N}) and the second set of weights (w_{2A}-w_{2N}) are determined through testing to determine which weight values result in maximized preservation of the spatialization of the audio input devices 104a-104n. According to another example, a set of machine readable instructions is implemented to determine the values of the weights, for instance, based upon responses to acoustics in relation to the positions of each of the audio input devices 104a-104n. In any regard, the weights in the first set of weights (w_{1A}-w_{1N}) and the second set of weights (w_{2A}-w_{2N}) may be stored in the data store 230 for access by the processor 220 during implementation of the method 300.

According to an example, the weighted left channel audio signals of the audio input devices 104a-104n are summed together to generate a summed left channel audio signal. In addition, the weighted right channel audio signals of the audio input devices 104a-104n are summed together to generate a summed right channel audio signal.

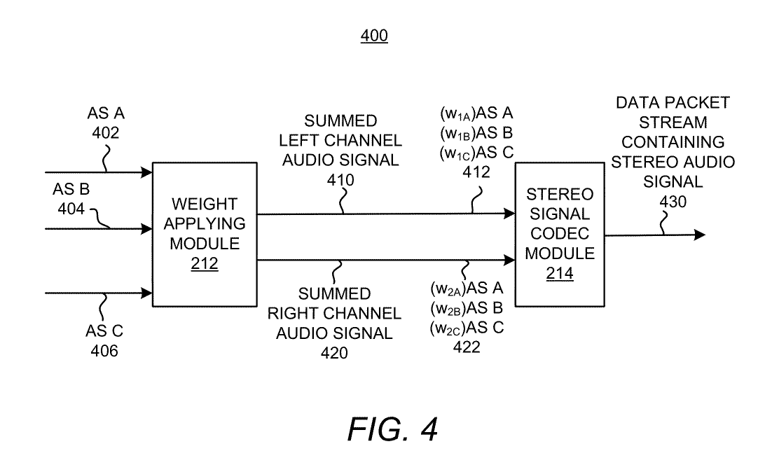

Turning now to FIG. 4, there is shown a diagram 400 that graphically depicts how the respective first and second weights are applied to each of the audio signals (AS) of three audio input devices 104a-104c to generate a summed left channel audio signal 410 and a summed right channel audio signal 420. As shown in FIG. 4, a first audio signal (AS A) 402 is received from a first audio input device 104a, a second audio signal (AS B) 404 is received from a second audio input device 104b, and a third audio signal (AS C) 406 is received from a third audio input device 104c.

In addition, for the left channel audio signal 412, the weight applying module 212 is depicted as applying a first weight (w_{1A}) for the first audio input device 102a to the first audio signal (AS A). The weight applying module 212 is also depicted as applying a first weight (w_{1B}) for the second audio input device 102b to the second audio signal (AS B) and a first weight (w_{1C}) for the third audio input device 102c to the third audio signal (AS C). For the right channel audio signal 422, the weight applying module 212 is depicted as applying a second weight (w_{2A}) for the first audio input device 102a to the first audio signal (AS A). The weight applying module 212 is also depicted as applying a second weight (w_{2B}) for the second audio input device 102b to the second audio signal (AS B) and a second weight (w_{2C}) for the third audio input device 102c to the third audio signal (AS C).

To further illustrate how the weights may be applied to the audio signals 402-406 in FIG. 4, the following Table I is provided. It should be clearly understood that the weights recited in the following Table I are for illustrative purposes only and that the weights are therefore not to be construed as limiting the present disclosure in any respect.

TABLE I

| Input Signal | First Weight (dB) | Second Weight (dB) |
|---|---|---|
| AS A 402 | (W_{1A}): 0 | (W_{2A}): −140 |
| AS B 404 | (W_{1B}): −12 | (W_{2B}): −12 |
| AS C 404 | (W_{1C}): −140 | (W_{2C}): 0 |

As shown in Table I, the first weight of “0 dB” applied to the first audio signal AS A 402 generally indicates that a maximum weight is applied to that audio signal, and thus, the first audio signal AS A 402 is not reduced by the first weight. In other words, the first weight applied to the first audio signal AS A 402 is a maximum value, which is equivalent to a multiplier of “1” in a linear scale. In contrast, the second weight of “−140 dB” applied to the first audio signal AS A 402 generally indicates that a minimum weight is applied to that audio signal to thereby cause the first audio signal AS A 402 to have little or no affect on the right channel audio signal. In other words, the “−140 dB” value is a numeric representation of infinity, which is equivalent to a multiplier of “0” in a linear scale, and which may make the first audio signal AS A 402 disappear Similarly, the first and second weights applied to the third audio signal AS C 404 generally indicates that the third audio signal AS C 404 has little or no affect on the left channel audio signal. Similarly, the first and second weights of “−12” applied to the second audio signal AS B 404 generally indicate that the second audio signal AS B 404 has the same affect on both the left and right channel audio signals.

As also shown in FIG. 4, the summed left channel audio signal 410 and the summed right channel audio signal 420 are supplied into the stereo signal codec module 214. With reference back to FIG. 3, at block 308, stereo audio signals containing the summed left channel audio signals 410 and the summed right channel audio signals 420 are generated, for instance, by the stereo signal codec module 214. More particularly, for instance, the stereo signal codec module 214 generates the stereo audio signal by combining the summed left channel audio signal 410 and the summed right channel audio signal 420. In addition, the stereo signal codec module 214 is to interleave the summed left channel audio signal 410 and the summed right channel audio signal 420 together and to incorporate the interleaved signals into a data packet stream 430 (FIG. 4).

Thereafter, the data packet stream containing the stereo audio signal 430 is outputted, for instance, to the audio signal outputting apparatus 124 in the second location 120 over the network 110, for instance, by the input/output module 210. The method 300 is to be repeated in continuous manner as the audio signal generating apparatus 106 continues to receive audio signals from the audio input devices 104a-104n. According to a particular example, for instance, when there is only a single audio input device, the left channel audio signals 410 and the right channel audio signals comprise the same values. In this example, a monoaural signal is communicated over the network 110.

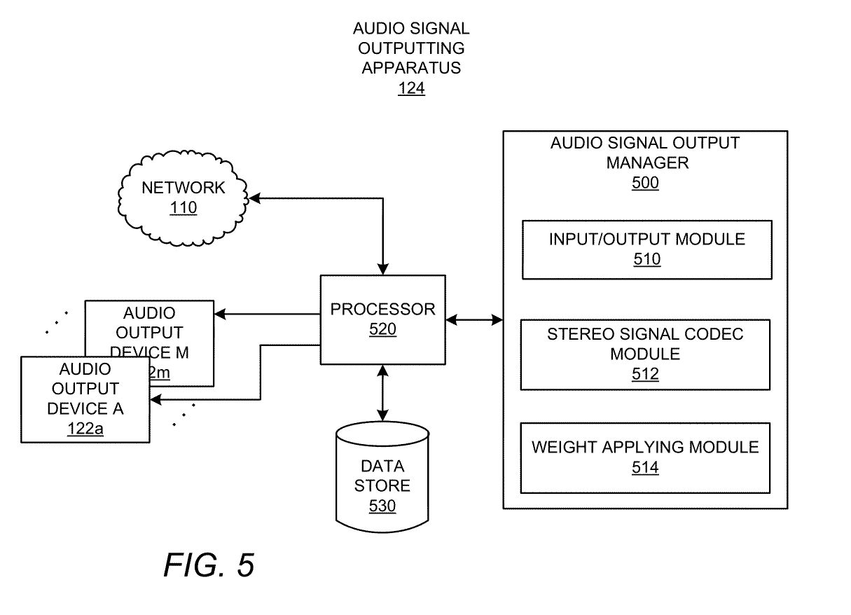

Turning now to FIG. 5, there is shown a block diagram of the audio signal outputting apparatus 124 depicted in FIG. 1, according to an example of the present disclosure. As shown in FIG. 5, the audio signal outputting apparatus 124 comprises an audio signal output manager 500, a processor 520, and a data store 530. The audio signal output manager 500 is also depicted as including an input/output module 510, a stereo signal codec module 512, and a weight applying module 514, and. The processor 520 is depicted as communicating with the audio output devices 122a-122m, the data store 530, and the network 110.

The audio signal outputting apparatus 124 comprises a server, a computer, or other electronic device comprising logic, hardware and/or software, to perform various functions described herein. In addition, the audio signal outputting manager 500 comprises at least one of hardware and machine readable instructions stored on a memory or an integrated chip programmed to perform various audio signal processing operations. In this regard, the modules 510-514 comprise at least one of software modules and/or hardware modules. The modules 510-514 thus may comprise machine-readable instructions that are stored, for instance, in a volatile or non-volatile memory, such as DRAM, EEPROM, MRAM, flash memory, floppy disk, a CD-ROM, a DVD-ROM, or other optical or magnetic media, and the like, and executable by the processor 520. According to an example, the modules 510-514 are stored in the data store 530, which comprises any of the above-listed types of memory. According to another example, the modules 510-514 comprise at least one hardware device, such as, a circuit or multiple circuits arranged on a printed circuit board that are controlled by the processor 520.

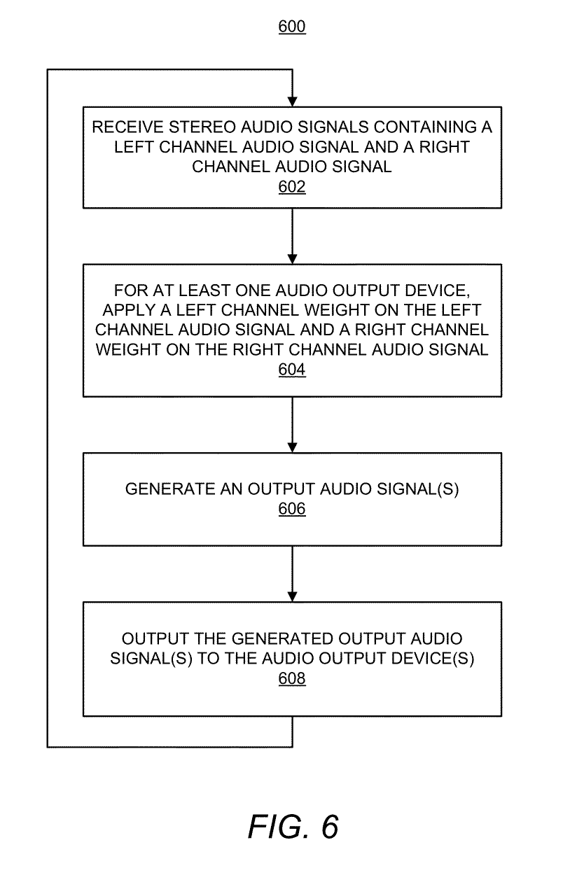

Various manners in which the modules 510-514 are implemented in accordance with examples of the present disclosure are described in greater detail below with respect to the method 600 depicted in FIG. 6. FIG. 6, more particularly, shows a flow diagram of a method 600 for outputting a stereo audio signal contained in a data packet stream, according to an example of the present disclosure. According to an example, the audio signal output manager 500 implements the method 600 to output the stereo audio signal in a manner that substantially preserves spatializations of the audio input devices 104a-104n in the outputs of the audio signals by the audio output devices 122a-122m.

At block 602, stereo audio signals containing a left channel audio signal and a right channel audio signal for output on at least one audio output device 122a-122m are received, for instance, by the input/output module 510. Alternatively, at block 602, stereo audio signals containing a left channel audio signal and a right channel audio signal for output on a plurality of spatially separate audio output devices 122a-122m are received, for instance, by the input/output module 510. More particularly, the input/output module 510 receives a data packet stream containing the stereo audio signals over the network 110, such as the data packet stream 430 in FIG. 4.

At block 604, a left channel weight is applied on the left channel audio signal and a right channel weight is applied on the right channel audio signal, for instance, by the weight applying module 514. Alternatively, at block 604, for each of the plurality of audio output devices 122a-122m through which the stereo audio signals are to be outputted, a respective left channel weight is applied on the left channel audio signal and a respective right channel weight is applied on the right channel audio signal, for instance, by the weight applying module 514. In other words, a left channel weight (w_{LA}) for a first audio output device 122a is applied to the left channel audio signal and a right channel weight (w_{RA}) for the first audio output device 122a is applied to the right channel audio signal. In addition, a left channel weight (w_{LB}) for a second audio output device 122b is applied to the left channel audio signal and a right channel weight (w_{RB}) for the second audio output device 122a is applied to the right channel audio signal. Moreover, a left channel weight (w_{LC}) for a third audio output device 122c is applied to the left channel audio signal and a right channel weight (w_{RC}) for the third audio output device 122c is applied to the right channel audio signal. Likewise, respective left channel weights (w_{LD-LN}) for the remaining audio input devices 104d-104n, if applicable, are applied to the left channel audio signal and respective right channel weights (w_{RD-RN}) for the remaining audio input devices 104d-104n, if applicable, are applied to the right channel audio signal. According to an example, the respective left channel weight is applied on the left channel audio signal and a respective right channel weight is applied on the right channel audio signal by multiplying the respective weights for the audio output devices 122a-122m with the audio signals, which may be in decibels, for instance.

According to an example, the values of the left and right channel weights for each of the audio output devices 122a-122m are to cause the left channel audio signals to be played predominantly through the audio output devices located more on the left side of the location 122. In this example, for instance, the left channel weight (w_{LA}) for the leftmost audio output device 122a is larger than the right channel weight (w_{RA}) for the leftmost audio output device 122a. Likewise, the right channel weight (w_{RN}) for the rightmost audio output device 122m is larger than the left channel weight (w_{LN}) for the rightmost audio output device 122m.

In some implementations, the respective left channel weights (w_{LA}-w_{LN}) and the respective right channel weights (w_{RA}-w_{RN}) comprise values that are based at least upon the spatial locations of the audio output devices 122a-122m through which the audio signals are to be outputted from the audio signal outputting manager 500. That is, the values of the respective left channel weights (w_{LA}-w_{LN}) and the respective right channel weights (w_{RA}-w_{RN}) are likely to differ in instances where there is a first number of audio output devices 122a-122m and where there is a second number of audio output devices 122a-122m. Likewise, the values of the respective left channel weights (w_{LA}-w_{LN}) and the respective right channel weights (w_{RA}-w_{RN}) are likely to differ in instances where the audio output devices 122a-122m are arranged in a first spatial arrangement and where the audio output devices 122a-122m are arranged in a second spatial arrangement. According to an example, the values of the respective left channel weights (w_{LA}-w_{LN}) and the respective right channel weights (w_{RA}-w_{RN}) are determined through testing to determine which weight values result in substantially optimized performance of the audio output devices 122a-122m. According to another example, a set of machine readable instructions is implemented to determine the values of the weights, for instance, based upon rendering of the audio output devices 122a-122m. In any regard, the respective left channel weights (w_{LA}-w_{LN}) and the respective right channel weights (w_{RA}-w_{RN}) may be stored in the data store 530 for access by the processor 520 during implementation of the method 600.

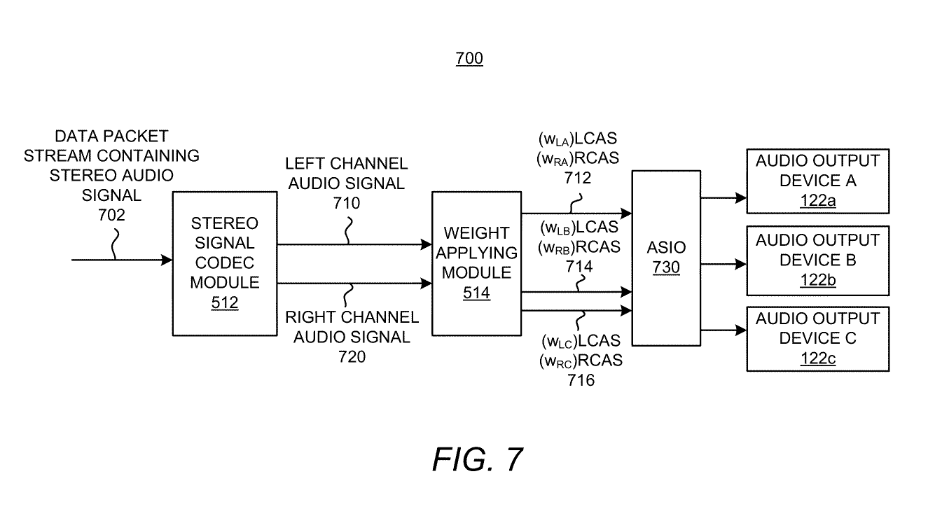

Turning now to FIG. 7, there is shown a diagram 700 that graphically depicts how the respective left and right weights for each of three audio output devices 122a-122c are applied to each of the left channel audio signal (LCAS) and the right channel audio signal (RCAS) for output of the weighted audio signals on the audio output devices 122a-122c. As shown in FIG. 7, the stereo signal codec module 512 receives a data packet stream containing stereo audio signals 702, which may comprise the data packet stream 430 (FIG. 4). For instance, the stereo signal codec module 512 receives the data packet stream 702 from the audio signal generating apparatus 106 through the network 110 as depicted in FIG. 1.

As discussed above, the stereo audio signal contained in the data packet stream 702 is formed of an interleaved pattern of a left channel audio signal 710 and a right channel audio signal 720. As shown in FIG. 7, the stereo signal codec module 512 demixes the left channel audio signal 710 and the right channel audio signal 720 from the stereo audio signal contained in data packet stream 702. In addition, the left channel audio signal 710 and the right channel audio signal 720 are inputted into the weight applying module 514. The weight applying module 514 applies respective left and right weights for each of the audio output devices 122a-122c to each of the left channel audio signal 710 and the right channel audio signal 720.

More particularly, for the first audio output device 122a, the weight applying module 514 applies a left channel weight (w_{LA}) for the first audio output device 122a to the left channel audio signal 710 and a right channel weight (w_{RA}) for the first audio output device 122a to the right channel audio signal 720. Likewise, for the second audio output device 122b, the weight applying module 514 applies a left channel weight (w_{LB}) for the second audio output device 122b to the left channel audio signal 710 and a right channel weight (w_{RB}) for the second audio output device 122b to the right channel audio signal 720. Moreover, for the third audio output device 122c, the weight applying module 514 applies a left channel weight (w_{LC}) for the third audio output device 122c to the left channel audio signal 710 and a right channel weight (w_{RC}) for the third audio output device 122c to the right channel audio signal 720.

As also shown in FIG. 7, the weighted left channel and right channel audio signals 712 for the first audio output device 122a, the weighted left channel and right channel audio signals 714 for the second audio output device 122b, and the weighted left channel and right channel audio signals 716 for the third audio output device 122c are depicted as being outputted by the weight applying module 514. Instead, however, and with reference back to FIG. 6, at block 606, the weight applying module 514 generates a respective output audio signal for each of the audio output devices 122a-122m. More particularly, for the first audio output device 122a, the weight applying module 514 sums the product of the left channel weight (w_{LA}) for the first audio output device 122a with the left channel audio signal 710 and the product of the right channel weight (w_{RA}) for the first audio output device 122a with the right channel audio signal 720, in which the sum constitutes the audio signal to be outputted by the first audio output device 122a. Likewise, for the second audio output device 122b, the weight applying module 514 sums the product of the left channel weight (w_{LB}) for the second audio output device 122b with the left channel audio signal 710 and the product of the right channel weight (w_{RB}) for the second audio output device 122b with the right channel audio signal 720, in which the sum constitutes the audio signal to be outputted by the second audio output device 122b. Moreover, for the third audio output device 122c, the weight applying module 514 sums the product of the left channel weight (w_{LC}) for the third audio output device 122c with the left channel audio signal 710 and the product of the right channel weight (w_{RC}) for the third audio output device 122c with the right channel audio signal 720, in which the sum constitutes the audio signal to be outputted by the third audio output device 122c. Furthermore, the weight applying module 514 performs the same operations for the remaining audio output devices 122d-122m, as applicable.

To further illustrate how the weights may be applied to the left channel audio signal 710 and the right channel audio signal 720 for each of audio output devices 122a-122c in FIG. 7, the following Table II is provided. It should be clearly understood that the weights recited in the following Table I are for illustrative purposes only and that the weights are therefore not to be construed as limiting the present disclosure in any respect.

TABLE II

| | Left Channel Weight | Right Channel Weight |
|---|---|---|
| Audio Output Device | (dB) | (dB) |
| Device A 122a | (W_{LA}): 0 | (W_{RA}): −140 |
| Device B 122b | (W_{LB}): −8 | (W_{LB}): −8 |
| Device C 122c | (W_{LC}): −140 | (W_{RC}): 0 |

As shown in Table II, the left channel weight of “0 dB” applied to the left channel audio signal 710 for the first output device 122a generally indicates that a maximum weight is applied to that audio signal, and thus, the signal is not reduced. In other words, the first weight applied to the left channel weight applied to left channel audio signal 710 for the first output device 122a is a maximum value, which is equivalent to a multiplier of “1” in a linear scale. In contrast, the right channel weight of “−140 dB” applied to the right channel audio signal 720 generally indicates that a minimum weight is applied to that audio signal to thereby cause the right channel audio signal 720 to have little or no affect on the output of the first output device 122a. In other words, the “−140 dB” value is a numeric representation of infinity, which is equivalent to a multiplier of “0” in a linear scale, and which may make the right channel audio signal 720 disappear for the first output device 122a. Similarly, the left and right channel weights applied to the left and right channel audio signals 710, 720 for the third audio output device 122c generally indicates that the right channel audio signal 720 is not reduced, whereas the left channel audio signal 710 has little or no affect on the output of the third output device 122c. Similarly, the left and right weights of “−8 dB” applied to the left and right channel audio signals 710 and 720, respectively, for the second audio output device 122b generally indicate that the left and the right channel audio signals 710 and 720 are reduced by the same levels and are outputted through the second audio output device 122b.

With reference back to FIG. 6, at block 608, the generated output audio signals are outputted to the respective audio output devices 122a-122m by, for instance, the input/output module 510. As shown in FIG. 7, the generated output audio signals are processed through an audio stream input/output (ASIO) 730, which communicates the output audio signals to the respective audio output devices 122a-122c. More particularly, for instance, the ASIO is associated with drivers that execute the actual signal data transport between the software layers of the audio signal generating apparatus 106 and audio output devices 122a-122m. In any regard, the output audio signal generated for the first output device 122a is outputted to the first output device 122a, the output audio signal generated for the second output device 122b is outputted to the second output device 122b, and so forth. The audio output devices 122a-122m receive the respective output audio signals and are to output acoustic waves corresponding to the decibel levels in the received output audio signals. It should be understood that some of the output audio signals may have zero decibel levels and thus those audio output devices 122a-122m that receive such output audio signals do not output acoustic waves. The method 600 is to be repeated in continuous manner as the audio signal outputting apparatus 124 continues to receive stereo audio signals.

Some or all of the operations set forth in the methods 300 and 600 may be contained as utilities, programs, or subprograms, in any desired computer accessible medium. In addition, the methods 300 and 600 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

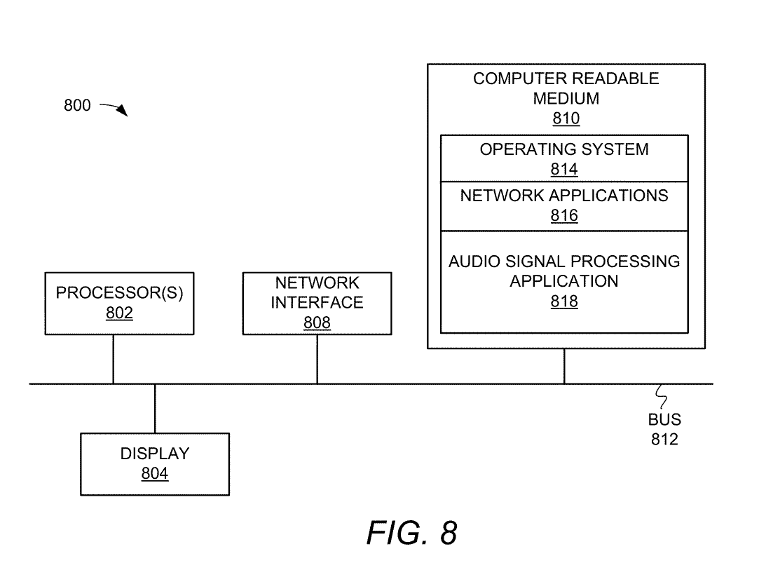

Turning now to FIG. 8, there is shown a schematic representation of a computing device 800, which may be employed to perform various functions of either or both of the audio signal generating apparatus 106 and the audio signal outputting apparatus 124 depicted in FIGS. 1, 2, and 5, according to an example. The device 800 includes a processor 802, a display device 804, such as a monitor; a network interface 808, such as a Local Area Network LAN, a wireless 802.11x LAN, a 3G mobile WAN or a WiMax WAN; and a computer-readable medium 810. Each of these components is operatively coupled to a bus 812. For example, the bus 812 may be an EISA, a PCI, a USB, a FireWire, a NuBus, or a PDS.

The computer readable medium 810 may be any suitable non-transitory medium that participates in providing instructions to the processor 802 for execution. For example, the computer readable medium 810 may be non-volatile media, such as an optical or a magnetic disk; volatile media, such as memory; and transmission media, such as coaxial cables, copper wire, and fiber optics.

The computer-readable medium 810 may also store an operating system 814, such as Mac OS, MS Windows, Unix, or Linux; network applications 816; and an audio signal processing application 818. The operating system 814 may be multi-user, multiprocessing, multitasking, multithreading, real-time and the like. The operating system 814 may also perform basic tasks such as recognizing input from input devices, such as a keyboard or a keypad; sending output to the display 804; keeping track of files and directories on the computer readable medium 810; controlling peripheral devices, such as disk drives, printers, image capture device; and managing traffic on the bus 812. The network applications 816 include various components for establishing and maintaining network connections, such as machine-readable instructions for implementing communication protocols including TCP/IP, HTTP, Ethernet, USB, and FireWire.

The audio signal processing application 818 provides various components for generating and/or outputting audio signals as described above with respect to the methods 300 and 600 in FIGS. 3 and 6 respectively. The audio signal processing application 818, when implemented, generates a stereo audio signal data stream and/or outputs a stereo audio signal data stream. In certain examples, some or all of the processes performed by the application 818 may be integrated into the operating system 814. In certain examples, the processes may be at least partially implemented in digital electronic circuitry, or in computer hardware, machine-readable instructions (including firmware and/or software), or in any combination thereof.

In the preceding disclosure, although the audio signal generating apparatus 124 and the audio signal outputting apparatus 124 have depicted and described as comprising separate devices, in various examples, the audio signal generating apparatus 124 and the audio signal outputting apparatus 124 form the same device. In these examples, a single device contains the components and performs the functions of both the audio signal generating apparatus 124 and the audio signal outputting apparatus 124. The combined device may be provided at multiple locations to thus enable both the generation and outputting of the stereo audio signals at the multiple locations.

In addition, it should be understood that the various aspects of the disclosure depicted in the figures may include additional elements and that some of the elements described herein may be removed and/or modified without departing from a scope of the present disclosure. Moreover, although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein are examples of the disclosure along with some of their variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for generating a stereo audio signal data packet stream, said method comprising:
receiving audio signals from at least one audio input device;
applying, by a processor, a first weight for the at least one audio input device to the audio signals to generate a plurality of weighted left channel audio signals;
applying, by the processor, a second weight for the at least one audio input device to the audio signals to generate a plurality of weighted right channel audio signals; and
generating stereo audio signals containing the weighted left channel audio signals and the weighted right channel audio signals.

2. The method according to claim 1, further comprising:
interleaving the stereo audio signal into a single data packet stream; and
outputting the single data packet stream.

3. The method according to claim 1, wherein receiving the audio signals further comprises receiving the audio signals from a plurality of audio input devices, wherein applying the first weight further comprises applying a first set of respective weights for the audio input devices to generate the plurality of weighted left channel audio signals, and wherein applying the second weight further comprises applying a second set of respective weights for the audio input devices to generate the plurality of weighted right channel audio signals, said method further comprising:
summing the plurality of weighted left channel audio signals together to generate a summed left channel audio signal;
summing the plurality of weighted right channel audio signals together to generate a summed right channel audio signal; and
wherein generating the stereo audio signal further comprises mixing the summed left channel audio signal with the summed right channel audio signal.

4. The method according to claim 3, wherein the plurality of audio input devices comprise a first audio input device, a second audio input device, and a third input device, and wherein the first audio input device is positioned on a first side of the second audio input device and the third input device is located on a second, opposite, side of the second audio input device, and wherein applying the first set of respective weights for the audio input devices to the audio signals to generate the plurality of weighted left channel audio signals further comprises:
applying a first weight for the first audio input device to the audio signal received from the first audio input device;
applying a first weight for the second audio input device to the audio signal received from the second audio input device; and
applying a first weight for the third audio input device to the audio signal received from the third audio input device, wherein the first weight for the first audio input device is larger than the first weight for the second audio input device and the first weight for the second audio input device is larger than the first weight for the third audio input device.

5. The method according to claim 4, wherein applying the second set of respective weights for the audio input devices to the audio signals to generate the plurality of weighted right channel audio signals further comprises:
applying a second weight for the first audio input device to the audio signal received from the first audio input device;
applying a second weight for the second audio input device to the audio signal received from the second audio input device; and
applying a second weight for the third audio input device to the audio signal received from the third audio input device, wherein the second weight for the first audio input device is smaller than the second weight for the second audio input device and the second weight for the second audio input device is smaller than the second weight for the third audio input device.

6. The method according to claim 3, wherein the first set of respective weights and the second set of respective weights for the audio input devices are based at least upon the spatial positions of the audio input devices from which the audio signals were received to capture substantially accurate spatial representations of the audio input devices from which the audio signals are received.

7. An apparatus for generating a stereo audio signal data packet stream, said apparatus comprising:
at least one module to receive audio signals from a plurality of audio input devices, wherein the audio input devices are arranged in spatially different positions with respect to each other, to apply a first set of respective weights for the audio input devices to the audio signals to generate a plurality of weighted left channel audio signals, to apply a second set of respective weights for the audio input devices to the audio signals to generate a plurality of weighted right channel audio signals, to generate a data packet stream containing the weighted left channel audio signals and the weighted right channel audio signals; and
a processor to implement the at least one module.

8. The apparatus according to claim 7, wherein the at least one module is further to sum the plurality of weighted left channel audio signals together to generate a summed left channel audio signal, to sum the plurality of weighted right channel audio signals together to generate a summed right channel audio signal, and to generate data packet stream to contain a mix of the summed left channel audio signal with the summed right channel audio signal.

9. The apparatus according to claim 7, wherein the plurality of audio input devices comprise a first audio input device, a second audio input device, and a third input device, and wherein the first audio input device is positioned on a first side of the second audio input device and the third input device is located on a second, opposite, side of the second audio input device, and wherein the at least one module, in applying the first set of respective weights for the audio input devices, is further to:
apply a first weight for the first audio input device to the audio signal received from the first audio input device;
apply a first weight for the second audio input device to the audio signal received from the second audio input device; and
apply a first weight for the third audio input device to the audio signal received from the third audio input device, wherein the first weight for the first audio input device is larger than the first weight for the second audio input device and the first weight for the second audio input device is larger than the first weight for the third audio input device.

10. The apparatus according to claim 9, wherein the at least one module, in applying the second set of respective weights for the audio input devices, is further to:
apply a second weight for the first audio input device to the audio signal received from the first audio input device;
apply a second weight for the second audio input device to the audio signal received from the second audio input device; and
apply a second weight for the third audio input device to the audio signal received from the third audio input device, wherein the second weight for the first audio input device is smaller than the second weight for the second audio input device and the second weight for the second audio input device is smaller than the second weight for the third audio input device.

11. A method comprising:
receiving stereo audio signals containing a left channel audio signal and a right channel audio signal for output on at least one audio output device, wherein the at least one audio output device is assigned a left channel weight and a right channel weight;
applying, by a processor, the left channel weight on the left channel audio signal and the right channel weight on the right channel audio signal;
generating audio signals to be outputted by the at least one audio output device from the applied left channel weight on the left channel audio signal and the right channel weights on the right channel audio signal; and
outputting the audio signals to the at least one audio output device.

12. The method according to claim 11, wherein the stereo audio signal comprises an interleaved data packet stream containing the left channel audio signal and the right channel audio signal, said method further comprising:
receiving data packets containing both the left channel audio signal and the right channel signal prior to applying the first weight on the left channel audio signal and the second weight on the right channel audio signal for the at least one audio output device to maintain synchronization between the left channel audio signal and the right channel signal.

13. The method according to claim 11, wherein receiving the stereo audio signals further comprises receiving the stereo audio signals containing a left channel audio signal and a right channel audio signal for output on a plurality of audio output devices, wherein each of the plurality of audio output devices is assigned a respective left channel weight and a respective right channel weight;
wherein applying the left channel weight and the right channel weight further comprises applying the respective left channel weight on the left channel audio signal and the respective right channel weight on the right channel audio signal for each of the audio output devices;
wherein generating the audio signals further comprises generating respective audio signals to be outputted by the respective audio output devices from the applied respective left channel weights on the left channel audio signal and the respective right channel weights on the right channel audio signal; and
wherein outputting the respective audio signals further comprises outputting the respective audio signals on the respective audio output devices

14. The method according to claim 13, wherein the applying the left channel weight on the left channel audio signal and the right channel weight on the right channel audio signal for each of the audio output devices further comprises:
applying a first left channel weight on the left channel audio signal and a first right channel weight on the right channel audio signal for the first audio output device; and
applying a second left channel weight on the left channel audio signal and a second right channel weight on the right channel audio signal for the second audio output device, wherein the first left channel weight is larger than the second left channel weight.

15. The method according to claim 13, wherein the left channel weight and the right channel weight for each of the audio output devices is based at least upon the spatial positions of the audio output devices from which the audio signals are outputted, wherein the left channel weights and the right channel weights are selected to substantially accurately represent spatial positions of audio input devices from which the stereo audio signals were received.

16. An apparatus comprising:
at least one module to receive stereo audio signals containing a left channel audio signal and a right channel audio signal for output on a plurality of spatially separate audio output devices, wherein each of the audio output devices is assigned a respective left channel weight and a respective right channel weight, to, for each of a plurality of spatially separated audio output devices, apply the respective left channel weight on the left channel audio signal and the respective right channel weight on the right channel audio signal, to generate respective audio signals to be outputted by the audio output devices from the applied respective left channel weights on the left channel audio signal and the respective right channel weights on the right channel audio signal, and to output the respective audio signals to the audio output devices; and
a processor to implement the at least one module.

17. The apparatus according to claim 16, wherein, in applying the left channel weight on the left channel audio signal and the right channel weight on the right channel audio signal for each of the audio output devices, the at least one module is further to:
apply a first left channel weight on the left channel audio signal and a first right channel weight on the right channel audio signal for the first audio output device; and
apply a second left channel weight on the left channel audio signal and a second right channel weight on the right channel audio signal for the second audio output device, wherein the first left channel weight is larger than the second left channel weight.

18. The apparatus according to claim 16, wherein the left channel weight and the right channel weight for each of the audio output devices is based at least upon the spatial positions of the audio output devices from which the audio signals are outputted, wherein the left channel weights and the right channel weights are selected to substantially accurately represent spatial positions of audio input devices from which the stereo audio signals were received.
